(19) United States
(12) Patent Application Publication
(10) Pub. No.: US 2013/0311515 A1
(43) Pub. Date: Nov. 21, 2013

(54) DEVICE FOR CONTROLLING DATA THAT IS IN PARTICULAR RELEVANT TO DIABETES

(71) Applicant: Max D. Van Gelder, Zurich (CH)

(72) Inventor: Max D. Van Gelder, Zurich (CH)

(21) Appl. No.: 13/981,707

(22) PCT Filed: Nov. 24, 2011
(86) PCT No.: PCT/EP2011/070926

§ 371 Date: Aug. 8, 2013

(30) Foreign Application Priority Data
Jan. 28, 2011 (CH) 00143/11

(51) Int. Cl. G06F 19/00

(52) U.S. Cl. CPC G06F 19/322
USPC 707/790

(57) ABSTRACT

The invention relates to a device for controlling data that is in particular relevant to diabetes, including logging and processing data of this type and providing data for measures, primarily for use in a non-medical environment. In order to be used in a non-medical environment, the device comprises means for logging, processing and storing personal details, nutritional values and diagnostic details and comprises wireless communication means.

The invention relates to a device for controlling data that is in particular relevant to diabetes, including logging and processing of data of this type and providing data for measures, primarily for use in a non-medical environment.

The invention also relates to a method for controlling and processing or regulating data that is in particular relevant to diabetes.

Overweight individuals or those suffering from diabetes usually only receive advice now and then, specifically with regard to their primary illness, and their medical treatment is usually also only adjusted sporadically. For example, nutritional advice/diet, weight loss, blood sugar measurements, etc. thus occur in a manner disassociated from one another and the concerned individual must himself formulate an applicable overall treatment plan or obtain suggestions for individual measures, particularly because he is familiar with the exact reactions of his own body. Here, necessary details, such as calorie intake, calorie demand, insulin administration, insulin dosing, etc. are usually based only on estimated values or values based on the experience of the respective patient. In addition, normal values have to be adjusted individually with each person. As a result, unnecessary or too few preparations are taken for example, or ineffective diets are followed, which lead to the known “yo-yo effect” and to increased susceptibility for excess weight, organ overload, diabetes and/or cardiovascular disorders. To improve this situation, monitoring devices have been proposed, for example by transmitting medicinal data to third parties via the Internet (US-A-2002/0016719, U.S. Pat. No. 6,024,699 or US-A-2004/0199409), including a response, where appropriate, in the form of instructions for modification of the medical treatment. The medicinal data are based here on performed activities, in particular the intake of food and drink or the administration of drugs. Similar, complex solutions are disclosed in EP-A-1512369, US-A-2008/0161651 or WO-A-01/45014, Direct contact with a professional or the like is required.

The invention is then based on the problem of developing a device for controlling data that is in particular relevant to diabetes, which provides the concerned individual with an applicable overall suggestion for individual measures for use in a non-medical environment, without prior or recurring consultation with a doctor, including logging and processing of data of this type. The object is achieved by the features in Claim 1. By combining nutritional advice, blood sugar measurement and, where appropriate, further diagnostic details in a combination device, not only is the data logging and data processing more reliable and more traceable, but objectified measures or dosings before the intake of food and drink or before administration of drugs can also be predefined without consultation with a doctor. Based on individual values, such as height, weight, calorie requirement, injection details and other guidelines specified by a doctor, food or insulin still to be ingested or administered can be calculated on the basis, inter alia, of the input of food already ingested earlier in the day and/or administered insulin values. This enables nutritional suggestions, inter alia before food is ingested, and makes it possible to maintain a constant, manageable blood sugar level without disadvantageous fluctuations, which are to be avoided. Very severe hyperglycaemia or hypoglycaemia in particular are particularly harmful, and a known objective is to achieve the lowest (normal) blood sugar value with the lowest number of hypoglycaemias. An active warning system can be available from the data.

Advantageous embodiments are disclosed in the dependent claims. The device may thus be a combination device and in particular a Smartphone, in which nutrition tables, the personal values, blood sugar measurements, injection suggestions, movement suggestions (sport), etc. are stored and retrievable.

A further object of the invention is to develop a method for controlling and processing or regulating data that is in particular relevant to diabetes. This object is achieved by the features in Claim 5.

Due to the logging and control or regulation of the aforementioned data, it is also possible to take into consideration whether the user is healthy and just wants to lose weight (nutrition and movement organiser), is diabetic and/or is a cardiovascular patient or kidney patient, or also a combination thereof.

Here, a measurement is initially taken and data is established reliably (for example blood sugar value), and the menu plan of the mealtimes is then created.

Based on results of the blood sugar measurement, quantities and components of food can be compiled or established. This may mean that less insulin is to be administered, yet hypoglycaemia is avoided.

Nutritional data is managed and supplemented in the combination device (computer science, data processing).

New foods and their nutritional values can be supplemented and taken into consideration.

Utilisation is kept up-to-date and can be retrieved independently of location, and, with a Smartphone or the like, web applications are also possible, that is to say operation is possible whether online or offline, even in a number of languages. When required, communication with external databases and/or with professionals is thus also possible.

With inclusion of current blood sugar measured values, reports regarding the progression of the blood sugar concentration or other values or indications for therapies can also be created, for example. The measured data, etc. can also be provided in turn for pharmaceutical research.

With utilisation of the invention, individual pieces of data concerning a person, food, relevant disorders and individual dietary requirements are initially logged, and interrelationships are established therefrom, which lead to a nutrition table retrievable accordingly in the combination device.

Diagnoses and performed measurements concerning individual disorders, inter alia, are logged and, where appropriate, are supplemented with medical details (laboratory, ECG, etc.) and are used to establish a catalogue of measures.

Individual measures with regard to nutrition, blood sugar value adjustment, insulin administration, etc. can in turn be retrieved from the catalogue of measures.

Separate and regular nutritional calculations can also be omitted, such as regular measurements of blood sugar values. The individual concerned merely has to comply with the retrieved measures at least over a relatively long period of time, that is to say for example it is possible to dispense with consultation with a nutritional computer and blood sugar measurement device.

The success of these measures can be checked by values measured in a laboratory and, where appropriate, adaptations of the default values can be made.

The device according to the invention will be described in greater detail hereinafter in an example on the basis of a drawing, in which:

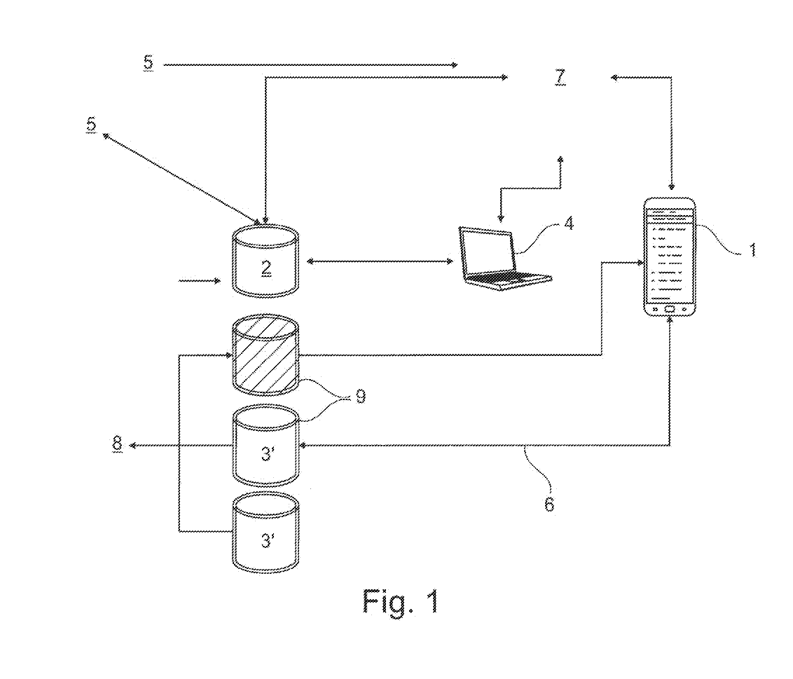

FIG. 1 shows a possible logical data flow, and

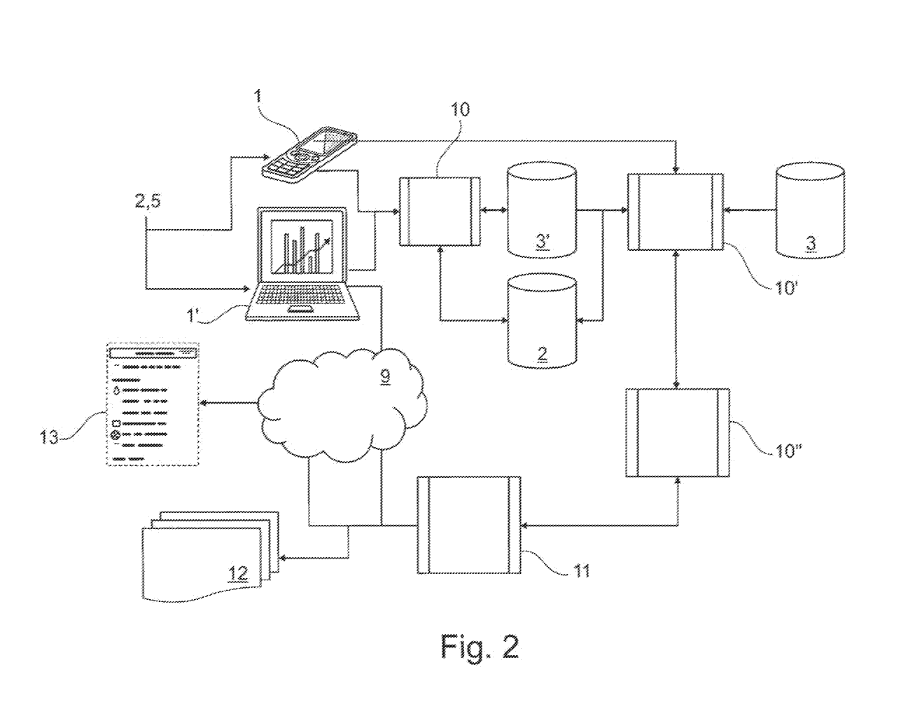

FIG. 2 shows the technical data flow.

The device comprises a database 2 containing personal information or drug information (active ingredient compendium), and also a further database 3 containing food information. Details 6 concerning new and unknown foods can also be entered at any time into the database (3′) containing food information by the user by means of a keypad, it being possible for these details to also be established or checked externally, for example in a pharmaceutical company, where appropriate. For this purpose, the database 3′ can be connected online to the pharmaceutical company.

The database 2 containing personal information is provided, inter alia, by a doctor 5 with personalised blood sugar values (HBA1C) etc., clinical pictures, drug administration patterns, etc. Furthermore, new research findings, for example from pharmaceutical research 8, could be added regularly.

The individual 7 inputs into a detection part of the device, for example a Smartphone 1, a food desire, and deviations are established and proposals for foods and food quantities that could be ingested, where appropriate in conjunction with insulin administration, are displayed in a processing unit with use of the databases 2, 4.

Where appropriate, further information can be drawn from external databases 4 and/or information, reports or statistics can be sent thereto. Both of these processes are preferably carried out online and wirelessly, where appropriate by means of a cloud 9.

As can be seen from FIG. 2, a patient (individual 7) is examined and instructed by a doctor and can input the details for his desired mealtime into the Smartphone 1. The databases 2, 3 are accessed online and the corresponding food details are established by means of a program 10 and are stored in the database 3 or 3′.

Deviations or differences compared to the permissible food intake are logged via the program 10′. A suitable suggestion is then established by means of the program 10″ and is displayed on the screen 13 of the Smartphone 1 or PC (1′). A warning module 11 informs the individual 7 via Smartphone 1 or the like of inadmissible differences between the food desire and established, permissible food values, and the individual 7 can make suitable corrections.

All established details can, in turn, be stored via transmission means in the form of reports 12, etc. in databases 2, 4.

Data logging, calculation and output of a suggestion require only little time and can therefore also be performed in restaurants or the like without difficulty.

The phases for logging a diagnosis system according to the invention can be as follows:

### I-II

Provision of personalised information, examination results and value transmission, HBA1C establishment

Food information (nutritional value, requirement, BMI)

Determination of deviations

Value calculation (statistics, reports, suggestions and nutritional advice)

### III-IV

Treatment alternatives, sport

### V-VI

Additions and support.

Calorie intake and also calorie burn are detected in accordance with formulas, wherein basic assumptions, such as regular calorie burn, time dependence or a basic reserve are made.

Advantageous features or characteristics are:
measurement of current blood sugar values *) (*) prior art)
individual identification *)
suggestions for medication, food, insulin administration
calculation of food values and automatic adaptation of food information
evaluation by means of uniform calculation bases
diagnosis after calculation, with inclusion of any illnesses (previous illnesses and/or secondary illnesses)
establishment of residence times of food
reporting *), warning system, studies

### LIST OF REFERENCE SIGNS

1 Smartphone
2 database
3 database
4 database
5 doctor
6 detail
7 individual
8 pharmaceutical research
9 cloud
10 program
11 warning module
12 report
13 screen

1. A device for controlling data that is in particular relevant to diabetes in a non-medical environment, said device comprising means for logging and processing and also storing personal details, nutritional values and diagnostic details in databases, means for communication with databases, and a processing unit for this information and an input and display unit for information to be input and/or for resultant information for self-control of an individual or for correction of measures.

2. The device according to claim 1, wherein the device is linkable to means for logging and processing blood sugar values.

3. The device according to claim 1 further comprising a unit for data input, a database containing personal information, a database containing food information, and wireless communication means.

4. The device according to wherein device is designed as a combination device, in particular as a Smartphone, and can be operated online or offline and/or is provided with a warning module.

5. A method for controlling and processing or regulating data that is in particular relevant to diabetes in a non-medical environment, said method comprising:
inputting personal details, in particular, height, age, weight, specific details concerning disorders, and also relevant medicinal details, inputting nutritional details, nutritional values, and the like,
processing the aforementioned details, and
retrieving resultant measures for self-control of an individual or for correction of measures.

6. The method according to claim 5, wherein a food desire is input and, as a result of the processing of the details, at least one proposal for food intake is displayed.

7. The method according to claim 5, wherein the blood sugar value is measured beforehand.

8. The method according to claim 6, wherein an insulin administration is displayed simultaneously as required.
